(19) United States
(12) Patent Application Publication
(10) Pub. No.: US 2013/0311667 A1
(43) Pub. Date: Nov. 21, 2013

(54) METHODS AND SYSTEMS FOR DYNAMIC POLICY EVALUATION

(71) Applicant: Avvasi Inc., Waterloo (CA)

(72) Inventor: Roxsan Payette, Ariss (CA)

(21) Appl. No.: 13/894,797

(22) Filed: May 15, 2013

Related U.S. Application Data
(60) Provisional application No. 61/646,990, filed on May 15, 2012.

(51) Int. Cl. H04L 29/08

(52) U.S. Cl. CPC H04L 67/14
USPC 709/228

(57) ABSTRACT

Methods and apparatus for managing a media session on a network device, and for selecting and applying policies to the media session. The network device may initially evaluate a general set of media session policies. A subset of the policies may be identified by selecting only those policies whose rules are currently satisfied, or whose rules are not presently satisfied but which may be satisfied when a fast-changing characteristic of the media session changes. Policies whose rules are not initially satisfied due to a slow-changing characteristic are not likely to be satisfied within the life of the media session, and can be excluded from the subset of policies. Thereafter, only the subset of selected policies need be re-evaluated during the media session.

### CROSS-REFERENCE TO RELATED APPLICATION

This application claims the benefit of U.S. Provisional Patent Application No. 61/646,990, filed 15 May 2012, the entire content of which is hereby incorporated by reference.

### FIELD

The described embodiments relate to controlling a media session. In particular, the described embodiments relate to controlling quality of a media session in a network environment based on one or more policies.

### BACKGROUND

The popularity of streaming media content over the Internet and other networks continues to increase. Maintaining such streaming is becoming a problem for the organizations providing and maintaining such networks.

Multimedia content on the Internet tends to be diverse and unmanaged. Multimedia services that provide real-time streaming may contribute significantly to the amount of traffic on mobile and other data networks. Mobile data networks in particular may be unable to support high bandwidth usage by a large number of devices during peak times or in overloaded areas, resulting in network congestion. In other cases, mobile devices may have limited bandwidth due to weak reception of a radio signal. Such conditions may result in a degraded user experience and impaired data usage more generally, among other problems.

### SUMMARY

In general, the described embodiments may use one or more policies to regulate the delivery of a media session between a media server and a client. In some cases, the policies applied to a media session may change during the lifetime of the media session. For example, based on changes in radio access network (RAN) utilization load levels, a new policy may be applied to cause a processor to correspondingly reduce the bandwidth required for the media session (e.g., by transcoding).

Media sessions may have characteristics associated with them, such as attributes of the media content itself, the subscriber or device consuming the media content, the network over which the content is being delivered, and others as described herein.

Some of these characteristics may be slow-changing, such as subscriber identity, subscriber plan or tier, device identity, etc. That is, a slow-changing characteristic is one that may change infrequently, or not at all, during the lifetime of a media session.

Other characteristics may be fast-changing, such as subscriber location, utilization load level at a particular location, audio or video bit rate, etc. Accordingly, a fast-changing characteristic is one that may change frequently during the lifetime of a media session.

Media session policies can be used by a network device to control the delivery of media sessions from a server to a client. A media session policy may define one or more conditions that can be evaluated based on media session characteristics. In general, a media session policy has one or more rules. Each rule may have one or more conditions that may be satisfied, and one or more actions that can be applied when the one or more conditions are satisfied.

A condition may be expressed in the form of conditional logic based on media session characteristics. For example, one condition may be expressed in prose as “bitrate is greater than 1500 kbps” although it will be understood that generally the conditions are expressed in a machine-readable form such as computer-interpretable code in an Extensible Markup Language (XML) file. Accordingly, if this condition is satisfied, an action associated with the rule (e.g., “transcode to bitrate of 500 kbps”) may be implemented, as described herein.

In some network environments, there may be a large number of media session policies to be evaluated. To provide flexible and responsive network control, it may be necessary to evaluate media session policies for a media session on a frequent basis, for example once every two seconds. In a busy network device that manages a large number of concurrent media sessions, this level of frequent evaluation of policies may impose a burden on processing resources.

To alleviate this burden, the described embodiments may initially evaluate a general set of media session policies. A subset of the policies may be identified by selecting only those policies whose rules are currently satisfied, or whose rules are not presently satisfied but which may be satisfied when a fast-changing characteristic of the media session changes. Policies whose rules are not initially satisfied due to a slow-changing characteristic are not likely to be satisfied within the life of the media session, and can be excluded from the subset of policies. Thereafter, only the subset of selected policies need be re-evaluated during the media session in question.

In the unlikely event that a slow-changing characteristic does change during the lifetime of the media session, the complete set of media session policies may again be re-evaluated.

However, in the more likely event that a fast-changing characteristic changes during the lifetime of the media session, only the subset of selected policies needs to be re-evaluated.

In a first broad aspect, there is provided a method of selecting session policies for a media session at a network device, the method comprising: detecting establishment of the media session at the network device; determining a plurality of characteristics of the media session; evaluating a set of session policies, based on at least one of the characteristics, to select a working set of session policies; and including a selected session policy for the media session in the working set of session policies, wherein the selected session policy has an expression that is not satisfied by each of the plurality of characteristics of the media session applicable to the selected session policy, and wherein the selected session policy is unenforced.

In some cases, the plurality of characteristics comprise at least one fast-changing characteristic, and the expression of the selected session policy is not satisfied by the at least one fast-changing characteristic when the set of session policies is initially evaluated.

In some cases, the at least one fast-changing characteristic is selected from the group consisting of a subscriber location, a location utilization load level, a current audio bit rate, a current video bit rate, an audio sampling rate, a number of audio channels, a video resolution, a video frame rate, an adaptive streaming control point, a current quality level, and a current quality metric for the media session.

In some cases, the plurality of characteristics comprise at least one slow-changing characteristic, and the working set can be selected by eliminating session policies with expressions that are not satisfied by the at least one slow-changing characteristic.

In some cases, the at least one slow-changing characteristic is selected from the group consisting of a subscriber identity, a subscriber plan, a time of day, a device identity, a device type, a device capability, a display size, a display resolution, a service type, a server address, a content duration, a streaming protocol, a media container, an audio codec and a video codec.

In some cases, the plurality of characteristics comprises at least one fast-changing characteristic, and the method may further comprise: monitoring the plurality of characteristics during the media session; and in response to a change in the plurality of characteristics, enforcing the selected session policy when the expression is satisfied by each of the plurality of characteristics of the media session applicable to the selected session policy.

In some cases, the plurality of characteristics further comprises at least one slow-changing characteristic, and the change is a change in the at least one fast-changing characteristic and each of the at least one slow-changing characteristic applicable to the selected session policy remains unchanged.

The method may further comprise re-evaluating the selected session policy prior to the enforcement. In some cases, the re-evaluating is performed by evaluating a sub-expression of the selected session policy, wherein the sub-expression is based on the at least one fast-changing characteristic.

The method may further comprise selecting a new working set of session policies in response to a change in the at least one slow-changing characteristic.

The method may further comprise including a second session policy for the media session in the working set of session policies, wherein the second session policy has an expression that is satisfied by each of the plurality of characteristics of the media session.

In another broad aspect, there is provided a non-transitory computer-readable medium storing instructions executable by a processor of a computer, the instructions which when executed by the processor cause the computer to carry out a method for selecting session policies for a media session at a network device, the method comprising: detecting establishment of the media session at the network device; determining a plurality of characteristics of the media session; evaluating a set of session policies, based on at least one of the characteristics, to select a working set of session policies; and including a selected session policy for the media session in the working set of session policies, wherein the selected session policy has an expression that is not satisfied by each of the plurality of characteristics of the media session applicable to the selected session policy, and wherein the selected session policy is unenforced.

In still another broad aspect, there is provided an apparatus for selecting session policies for a media session at a network device, the apparatus comprising: a memory; a network interface; and a processor, the processor configured to: detect establishment of the media session; determine a plurality of characteristics of the media session; evaluate a set of session policies, based on at least one of the characteristics, to select a working set of session policies; and include a selected session policy for the media session in the working set of session policies, wherein the selected session policy has an expression that is not satisfied by each of the plurality of characteristics of the media session applicable to the selected session policy, and wherein the selected session policy is unenforced.

In some cases, the plurality of characteristics comprise at least one fast-changing characteristic, and the expression of the selected session policy is not satisfied by the at least one fast-changing characteristic when the set of session policies is initially evaluated.

In some cases, the plurality of characteristics comprise at least one slow-changing characteristic, and the working set is selected by eliminating session policies with expressions that are not satisfied by the at least one slow-changing characteristic.

In some cases, the plurality of characteristics comprises at least one fast-changing characteristic, and the processor is further configured to: monitor the plurality of characteristics during the media session; and in response to a change in the plurality of characteristics, enforce the selected session policy when the expression is satisfied by each of the plurality of characteristics of the media session applicable to the selected session policy.

In some cases, the plurality of characteristics further comprises at least one slow-changing characteristic, and the change is a change in the at least one fast-changing characteristic and each of the at least one slow-changing characteristic applicable to the selected session policy remains unchanged.

In some cases, the processor is further configured to re-evaluate the selected session policy prior to the enforcement. In some cases, the re-evaluating is performed by evaluating a sub-expression of the selected session policy, wherein the sub-expression is based on the at least one fast-changing characteristic.

In some cases, the processor is further configured to select a new working set of session policies in response to a change in the at least one slow-changing characteristic.

### BRIEF DESCRIPTION OF THE DRAWINGS

Preferred embodiments will now be described in detail with reference to the drawings, in which:

FIG. 1 is a simplified block diagram of a network with a media session control system in accordance with an example embodiment;

FIG. 2 is a simplified block diagram of a network of the media session control system of FIG. 1;

FIG. 3 is a block diagram illustrating the structure of an example policy; and

FIGS. 4A and 4B are flow diagrams of an example method of selecting session policies for a media session at a network device in accordance with an example embodiment.

The drawings are provided for the purposes of illustrating various aspects and features of the example embodiments described herein. Where considered appropriate, reference numerals may be repeated among the figures to indicate corresponding or analogous elements.

### DESCRIPTION OF EXEMPLARY EMBODIMENTS

It will be appreciated that numerous specific details are set forth in order to provide a thorough understanding of the example embodiments described herein. However, it will be understood by those of ordinary skill in the art that the embodiments described herein may be practiced without these specific details. In other instances, well-known methods, procedures and components have not been described in detail so as not to obscure the embodiments described herein.

The embodiments of the systems and methods described herein may be implemented in hardware or software, or a combination of both. These embodiments may be implemented in computer programs executing on programmable computers, each computer including at least one processor, a data storage system (including volatile memory or non-volatile memory or other data storage elements or a combination thereof), and at least one communication interface. For example, and without limitation, the various programmable computers may be a server, network appliance, set-top box, embedded device, computer expansion module, personal computer, laptop, mobile telephone, smartphone or any other computing device capable of being configured to carry out the methods described herein.

Each program may be implemented in a high level procedural or object oriented programming or scripting language, or both, to communicate with a computer system. However, alternatively the programs may be implemented in assembly or machine language, if desired. The language may be a compiled or interpreted language. Each such computer program may be stored on a non-transitory computer-readable storage medium (e.g., read-only memory, magnetic disk, optical disc). The storage medium so configured causes a computer to operate in a specific and predefined manner to perform the functions described herein.

While particular combinations of various functions and features are expressly described herein, other combinations of these features and functions are possible that are not limited by the particular examples disclosed herein, and these are expressly incorporated within the scope of the present invention.

As the term module is used in the description of the various embodiments, a module includes a functional block that is implemented in hardware or software, or both, that performs one or more functions such as the processing of an input signal to produce an output signal. As used herein, a module may contain sub-modules that themselves are modules.

The described policy engine methods and systems generally allow for a plurality of media session policies to be applied to one or more media sessions. In particular, the described policy engine methods and systems allow for a subset of a general set of media session policies to be associated with an individual media session, and for that subset to be dynamically evaluated through the lifetime of the media session.

Such a policy engine maybe implemented as a stand-alone multimedia policy decision point (PDP), that is, a location where multimedia policy decisions are made, or in an integrated multimedia PDP and policy enforcement point (PEP), such as a media session control system referenced herein.

Given that characteristics such as utilization load level and quality level may change and be updated frequently (e.g. every second, every time a new media session is identified, etc.), given that the policy expressions may consists of several complex logical conditions, and given that the policy repository may contain a large number of policies, it would be inefficient to re-evaluate all policies after every change in the network environment.

Rather, it is generally more efficient to initially select a subset of policies that are capable and likely to be applied during the lifetime of each specific session, even if not necessarily at session start-up. Thereafter, incremental re-evaluation of the selected subset of policies can be performed when an underlying trigger changes or toggles.

In some embodiments described herein, a quaternary logic approach may be used to enable this using “soft-matching” rule expressions.

A distinction may be drawn between evaluating and selecting policies. Evaluating generally involves determining the result of a logical expression at a specific point in time. Selecting generally involves retaining those policies that currently evaluate as “TRUE”, or which may conceivably evaluate as “TRUE” within the lifetime of a media session, and discarding those policies that will always evaluate as “FALSE” within the lifetime of the media session. Therefore, “selecting” implies “evaluating”.

“Selecting” further implies that substantially all policies within the general set are initially examined and those which initially do or eventually might evaluate to “TRUE” are placed within an entity which may be referred to the working set. In the presence of dynamic conditions, only policies in the working set need to be re-evaluated when an underlying sub-condition changes.

To facilitate the selection of a working set and dynamic re-evaluation of a working set, it may be helpful to categorize media session characteristics as slow-changing or fast-changing. Slow-changing characteristics may include subscriber identity, subscriber plan or tier, time of day, device identity, device type and capabilities, display size, display resolution, service type, server address, clip or content duration, streaming protocol, media container, audio codec, video codec, and the like. That is, a slow-changing characteristic is one that may change infrequently, or not at all, during the lifetime of a media session.

For example, one slow-changing characteristic may be a device capability, such as the ability to decode media content in a selected format (e.g., H.264, H.265, etc.). The ability of a particular device to decode a specific format is generally fairly static, and this is unlikely to change during the lifetime of a media session. That is, a mobile device that is capable of decoding H.264 but not H.265 is not likely to gain the ability to decode H.265 content during the lifetime of a media session.

Fast-changing characteristics are those that may change every few seconds, or sub-seconds, and may include subscriber location, location utilization load level, current audio or video bit rate, audio sampling rate, audio channels, video resolution, video frame rate, adaptive streaming control point, current quality level or metric, and the like. Accordingly, a fast-changing characteristic is one that may change frequently during the lifetime of a media session.

Quality level is one example of a fast-changing characteristic. Conventionally, the quality level may be assessed based on factors such as format, encoding options, resolutions and bit rates. The large variety of services using different options, coupled with the wide range of devices on which content may be viewed, has conventionally resulted in widely varying quality across sessions and across viewers.

The described methods and systems, however, may apply policies to media sessions based on a more comprehensive quality metric, for example based on a quality of experience (QoE) score. In some cases, the quality metric may be in the form of a numerical score. In some other cases, the quality metric may be in some other form, such as, for example, a letter score, a descriptive (e.g. ‘high’, ‘medium’, ‘low’) etc. The quality metric may be expressed as a range of scores or an absolute score.

A quality metric on a Mean Opinion Score (MOS) scale is one example of a quality metric, which reflects a viewer's opinion of the quality of the media session. The terms quality metric and QoE score may be used interchangeably herein. However, a person skilled in the art will understand that other quality metrics may also be used.

A QoE score can be considered a systematic way of capturing how well a user is satisfied with a media presentation, or is likely to be satisfied. Generally, a QoE score may reflect a user's actual or anticipated viewing quality of the media session. QoE scores can be computed for the entirety of a media session, or computed periodically throughout a media session.

A QoE score may in some cases consist of two separate scores, for example a Presentation Quality Score (PQS) and a Delivery Quality Score (DQS).

PQS generally measures the quality level of a media session, taking into account the impact of media encoding parameters and optionally device-specific parameters on the user experience. These parameters may be incorporated into a no-reference bitstream model of satisfaction with the quality level of the media session. KPIs that can be used to compute the PQS may include media session characteristics such as codec type, resolution, bit rate, frame rate, device type, display size, and display resolution. Additional KPIs may include coding parameters parsed from the bitstream, such as macroblock quantization parameter, motion field complexity, etc.

DQS generally measures the success of the network in streaming delivery, reflecting the impact of network delivery on QoE while ignoring the source quality. DQS may be based on a set of factors, such as, the number, frequency and duration of re-buffering events, the delay before playback begins at the start of the session of following a seek operation, buffer fullness measures (such as average, minimum and maximum values over various intervals), and durations of video downloaded/streamed and played/watched.

In cases where adaptive bit rate streaming is used, additional factors may include a location, duration and frequency of stream switch events, as well as the noticeability of the stream switch event and the quality level (or PQS) of the operating point.

Each media session policy may define one or more actions to be carried out when conditions are satisfied. Actions may include, for example, shaping (e.g., controlling or limiting throughput), denying or terminating the media session, transcoding the media content in the media session (e.g., to change format, bitrate, resolution, frame rate, etc.), substituting media content in the media session (e.g., replacing a first video with a second video), inserting media content in the media session (e.g., advertising), request-response modification, manifest modification and various other actions.

In adaptive streaming control approaches, request-response modification may cause client segment requests for high definition content to be replaced with similar requests for standard definition content. Manifest editing may include modifying the media stream manifest files that are sent in response to a client request to modify or reduce the available operating points in order to control the operating points that are available to the client. Accordingly, the client may make further requests based on the altered manifest.

The described methods and systems generally enable a network device to service and apply media session policies to a large number of concurrent media sessions.

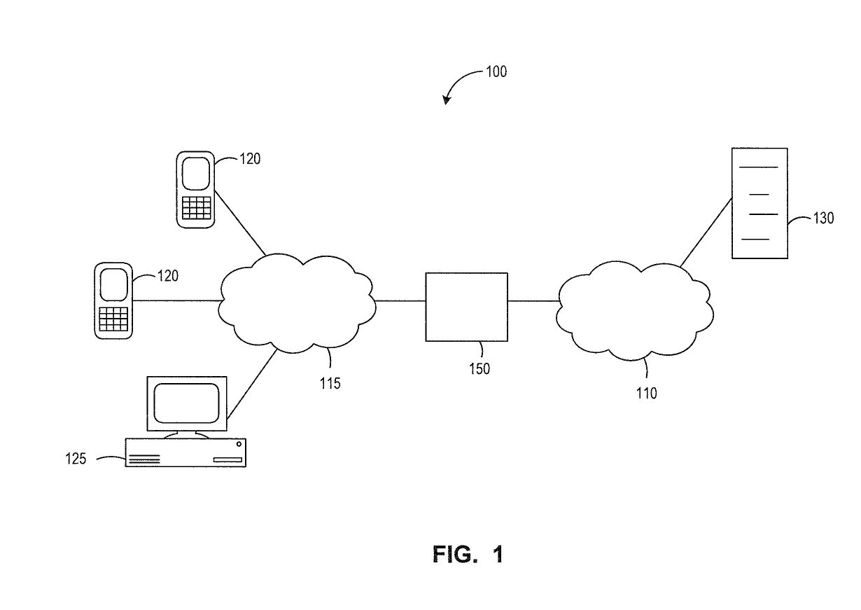

Referring now to FIG. 1, there is illustrated a simplified block diagram of a network with a media session control system in accordance with an example embodiment.

System 100 generally includes a data network 110, such as the Internet, which enables data communication between a media server 130 and a media session control system 150.

Media session control system 150 is further connected to one or more access networks 115 for client devices 120 and 125, which may be personal computers, mobile computing devices such as smartphones, set-top boxes, or other media devices, for example. In some cases, access networks 115 may include radio access networks (RANs) and backhaul networks, in the case of a wireless data network. Although the exemplary embodiments are shown primarily in the context of mobile data networks, it will be appreciated that the described systems and methods are also applicable to other network configurations. For example, the described systems and methods could be applied to data networks using satellite, digital subscriber line (DSL) or data over cable service interface specification (DOCSIS) technology in lieu of, or in addition to a mobile data network. Accordingly, in other embodiments, access networks 115 may be absent, and client devices 120 or client computers 125 may be connected to media session control system 150 directly, or via network 110 (e.g., in a proxy arrangement).

Media session control system 150 is generally configured to forward data packets associated with the data sessions of each client device 120 to and from network 110, preferably with minimal latency. In some cases, as described herein further, media session control system 150 may modify the data sessions, particularly in the case of media sessions (e.g., streaming video or audio).

Client devices 120 and 125 generally communicate with one or more servers 130 accessible via network 110. It will be appreciated that servers 130 may not be directly connected to network 110, but may be connected via intermediate networks or service providers. In some cases, servers 130 may be edge nodes of a content delivery network (CDN).

It will be appreciated that system 100 shows only a subset of a larger network, and that data networks will generally have a plurality of networks, such as network 110 and access networks 115.

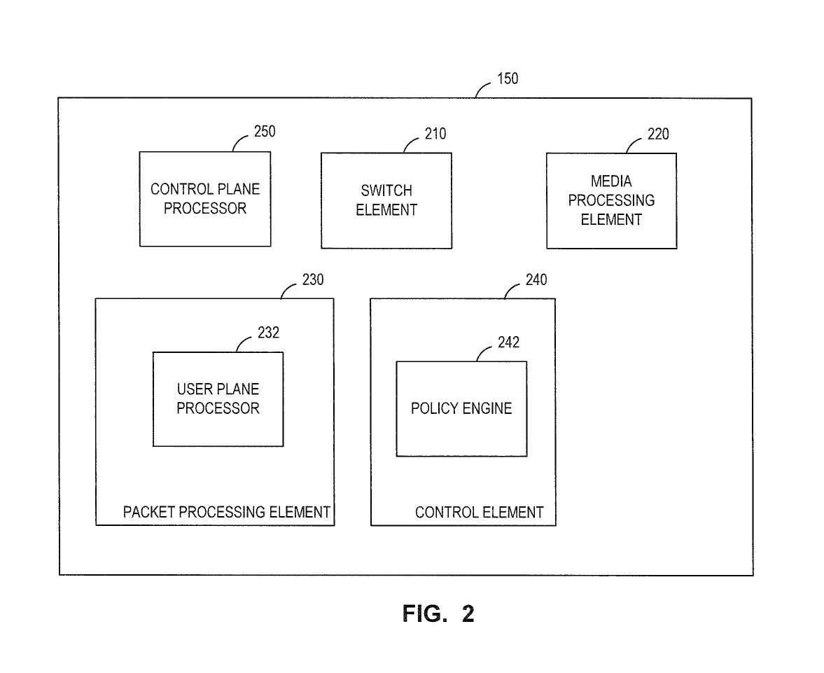

Referring now to FIG. 2, there is illustrated a simplified block diagram of the media session control system 150 of FIG. 1, according to one example embodiment.

Media session control system 150 is generally configured to route any generic network data traffic for client devices, such as client device 120, to and from a network, such as network 110 and the Internet. However, media session control system 150 can be further configured to identify media sessions in generic network data traffic, and to permit selective media session-based policy execution and traffic management of in-progress communication sessions (“flows”). This is a significant enhancement over conventional per-flow or per-subscriber application of policies, in which policies are applied to individual flows (on a per packet or per flow basis) or applied to all data for a particular subscriber (per subscriber). Media session control system 150 may be configured to determine and enforce media session-based policies to balance the overall quality of experience (QoE) and network utilization for all users, based on the service provider's policy rules. Determinations and enforcement can be performed by working in a closed-loop mode, using continuous real-time feedback to optimize and tune individual media sessions. In conjunction with detailed media session analysis and reporting, media session control system 150 may provide control and transparency to service providers attempting to manage rapidly growing media traffic on their network.

To accomplish this, media session control system 150 may perform a number of functions that would conventionally be implemented via separate interconnected physical appliances. Implementation in an integrated architecture, which supports a wide range of processor options, is beneficial in order to reduce cost while improving performance and reliability. Accordingly, media session control system 150 may have one or more switch elements 210, one or more media processing elements 220, one or more packet processing elements 230, one or more control elements 240, and one or more control plane processors 250, in an integrated platform. In some embodiments, the function of one or more of switch elements 210, media processing elements 220, packet processing elements 230, control elements 240, and control plane processors 250 may be integrated, such that a subset of the elements implements the entire functionality of media session control system 150 as described herein. In some embodiments, one or more of the elements may be implemented as a server “blade”, which can be coupled together via a backplane. Each of the elements may comprise one or more processors and memories.

Switch elements 210 may be configured to perform control and user plane traffic load balancing across packet processing elements. Each switch element 210 may comprise one or more load balancers configured to distribute traffic from a large number of subscribers evenly across one or more packet processing elements 230. The traffic may be re-balanced between one or more packet processing elements 230 in the event of a packet processing element 230 failure.

Switch elements 210 may be configured to operate the media session control system 150 in one or more of a number of intersection modes. The intersection modes may permit passive monitoring of traffic, active management of traffic, or a combination thereof, for example by using an appropriate virtual local area network (VLAN) configuration.

Switch element 210 may be configured to allow packets that do not relate to media sessions to be forwarded without further processing, resulting in minimal added latency, while permitting packets that may relate to media sessions to be subjected to further processing.

Media processing element 220 may be configured to perform inline, real-time, audio and video transcoding of selected media sessions. Media processing element 220 may comprise one or more general purpose or specialized processors. Such specialized processors may be optimized for media processing, such as integrated media processors, digital signal processors, or graphics processing units.

Such processors operate on media processing element 220 and may implement individual elementary stream transcoding on a per-segment basis. A segment can be defined as a collection of sequential media samples, which starts at a selected or random access point. The processors may exchange control and configuration messages and compressed media samples with one or more packet processing elements 230.

Media processing element 220 may generally perform bit rate reduction. In some cases, media processing element 220 may perform sampling rate reduction (e.g., spatial resolution and/or frame rate reduction for video, reducing sample frequency and/or number of channels for audio). In some other cases, media processing element 220 may perform format conversion for improved compression efficiency, whereby the output media stream being encoded may be converted to a different, more efficient format than that of the input media stream being decoded (e.g., H.264/AVC vs. MPEG-4 part 2).

Control element 240 may generally perform system management and (centralized) application functions. System management functions may include configuration and command line interfacing, Simple Network Monitoring Protocol (SNMP) alarms and traps and middleware services to support software upgrades, file system management, and system management functions.

Control element 240 may generally comprise a processor and memory configured to perform centralized application functions. Centralization of processing at control element 240 may be advantageous as, due to load balancing, no single packet processing element 230 generally has a complete view of all sessions within a given network device, nor a view of all network devices.

Control element 240 may include a policy engine 242. The policies available at the media session control system 150 may be dynamically changed by, for example, a network operator. In some cases, the policy engine 242 of the control element 240 may access policies located elsewhere on a network. For example, the policy engine 242 may gather media session policies based on the 3rd Generation Partnership Project (3GPP) Policy Control and Charging (PCC) architecture ecosystem (e.g., with a Policy Charging and Rules Function (PCRF)). In such embodiments, the policy system may enforce policy (i.e., carry out a Policy Control Enforcement Function (PCEF) with Application Function (AF), or Application Detection and Control (ADC)).

The policy engine 242 may maintain and evaluate a set of policies, including media session policies, and other configuration settings in order to perform active control and management of media sessions. In operation, policy engine 242 may dynamically evaluate and re-evaluate one or more policies for each media session under management by system 150.

In some cases, the policy engine 242 is configurable and may be dynamically changed by a network operator. For example, in some embodiments, policy engine 242 may be implemented as part of a PCRF server.

The policy engine 242 may also access and use subscriber information. In some cases, subscriber information may be based on subscriber database data obtained from one or more external subscriber databases. Subscriber database data may include quotas and policies specific to a user and/or a subscription tier. The subscriber database may be accessed via protocols such as Diameter, Lightweight Directory Access Protocol (LDAP), web services or other proprietary protocols. Subscriber database data may be enhanced with subscriber information available to the system 150, such as a usage pattern associated with the subscriber, types of multimedia contents requested by the subscriber in the past, the current multimedia content requested by the subscriber, time of the day the request is made and location of the subscriber making the current request, etc.

Packet processing element 230 may be generally configured to analyze user plane traffic across all layers of the TCP/IP (or UDP/IP, or other equivalent) networking stack and identify media sessions via user plane processor 232.

The packet processing element 230 may be configured to immediately re-enqueue packets that do not require advanced processing “back to the wire” with very low latency. Packets that require additional processing can be forwarded internally for deeper processing.

Deeper processing may include parsing of the transport, application and container layers of received/sent user plane packets, and execution of policy based on subscriber, device, location or media session analysis and processing, for example. The packet processing element 230 may forward general data traffic information and specifically media session information, e.g. bit rates, TCP throughput, RTT, etc., to other elements.

In some cases, some status characteristics may be inserted “in band” into user plane data, for example via HTTP enrichment. In these cases, packet processing element 230 can be configured to receive and parse control plane messages inserted by nodes in the radio access network.

In some cases, control plane processor 250 may be configured to process control plane messages to extract subscriber identity or mobile device identity information, and to map the mobile devices (e.g., physical or geographic location). Control plane processor 250 may forward the identity and location information to other elements.

For example, in mobile networks using 3GPP GRPS/UMTS, LTE, or similar standards, subscriber and mobile device identity information, location, as well as other mobility parameters may be gathered for subscriber, device, and location-based traffic management and reporting purposes. This can be accomplished in part by inspecting control plane messages exchanged between gateways, for example GTP-C (GPRS Tunneling Protocol Control) over the Gn interface, GTPv2 over the S4/S11 or S5/S8 interfaces, and the like, or by receiving mobility information from other network nodes, such as the RNC, Mobile Management Entity (MME) and the like.

In some cases, some status characteristics may be inserted “in band” in control plane data, for example via GTP enrichment. In these cases, control plane processor 250 can be configured to receive and parse control plane messages inserted by nodes in the radio access network.

A media session may generally be considered to have been identified once sufficient traffic relating to that media session has been observed at the application layer. In most cases, the application layer protocols used for media streaming can generally be identified by analyzing the first few bytes of payload data. After identifying the application payload, the payload can be parsed to find the media content, if any. This can be performed by dividing the communication into independent interactions, which may correspond to individual request/response pairs. Each interaction is evaluated to determine if the content is streaming media. If the interaction contains streaming media, it is further analyzed to extract media characteristics. Those interactions sharing common media characteristics may be encapsulated into streams. A media session may comprise a collection of one or more streams.

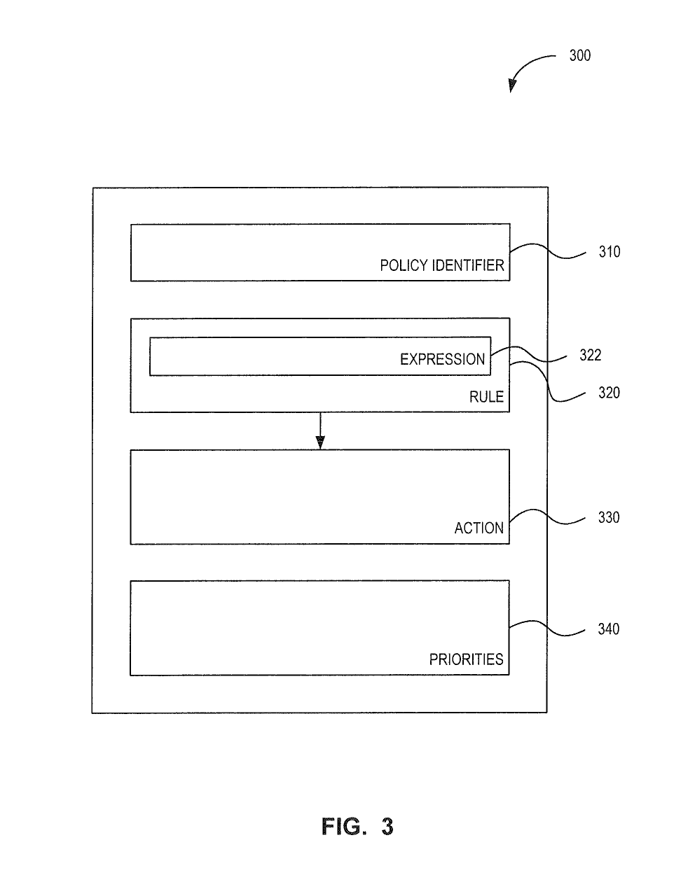

Referring now to FIG. 3, there is illustrated the structure of an example policy 300.

Generally, each policy 300 includes at least one rule 320 and at least one action 330 to be carried out when the rule 320 is satisfied. Optionally, policy 300 may include other elements, such as policy identifier 310 (e.g., a unique name or identifier) and one or more priorities 340.

Each rule 320 has at least one logical expression 322, which sets out the scope or constraints of the rule 320 and policy 300. A logical expression traditionally yields a Boolean result (e.g., “TRUE” or “FALSE”) and may be composed of one or more relational expressions connected by logical operators (AND, OR, NOT) that compare slow- or fast-changing media session characteristics. A relational expression that includes a fast-changing media session characteristic may be referred to as a dynamic trigger.

For example, a logical expression 322 may take the form of:

(VideoCodec=H.264) AND (PresentationQoE>MinimumQuality)

In this example, there are two relational expressions, one based on a slow-changing characteristic, “VideoCodec” (i.e., “VideoCodec=H.264”), and one based on a fast-changing characteristic, “PresentationQoE” (i.e., “PresentationQoE>MinimumQuality”). The “PresentationQoE>MinimumQuality” relational expression may also be referred to as a dynamic trigger. In some cases, variables may be hard-coded (e.g., 1000 kbps), or they may be constants or variables defined elsewhere, and in some embodiments constants or variables may themselves be considered to be slow-changing characteristics.

The logical expression may evaluate as “TRUE” or “FALSE” depending on the specific values of VideoCodec, PresentationQoE and MinimumQuality.

As described herein, fast-changing characteristics may include quality levels, which may be compared against pre-defined target quality levels. The target quality level may be an absolute quality level, such as, a numerical value on a MOS scale. The target quality level may alternatively be a QoE range, i.e., a range of values with a minimum level and a maximum level. A policy engine may specify a wide variety of quality metrics and associated target quality levels. In some cases, the quality metric may be based on an acceptable encoding and display quality (e.g., Presentation QoE). In some other cases, the quality metric may be based on an acceptable network transmission and stalling impact on quality (e.g., Delivery QoE). In some further cases, the quality metric may be based on the combination of the Presentation and the Delivery QoE scores, or a combined QoE score (CQS).

It will be appreciated that a virtually unlimited variety of policy rules can be created by crafting logic expressions using the available media session characteristics and other variables and constants.

When a rule 320 is evaluated and returns a positive (“TRUE”) result, one or more actions 330 may be specified to be carried out by some element of system 150. The action may be hardcoded, or may be computed based on media session characteristics and other variables and constants.

As described herein, the action 330 may include an instruction to reduce the bit rate of a media session, for example by transcoding media session content or by implementing an adaptive streaming action, such as limiting the available control points.

A policy engine may determine policy actions for media session, which may include a plurality of actions. For example, a policy action may include access control, a transcoding action, a re-multiplexing action, client-aware buffer shaping, packet marking, an adaptive streaming action which may also include a transcoding action, traffic shaping or policing, or some combination thereof.

Priorities 340 can be integer values for prioritizing policy rules relative to each other. This provides a basic mechanism for resolving policy conflicts.

Conflicts may occur in the case where a media session satisfies the conditions of multiple policy rules and the actions associated with those rules are incompatible. By giving rules different priorities, the policy engine can select the policy rule with the highest priority.

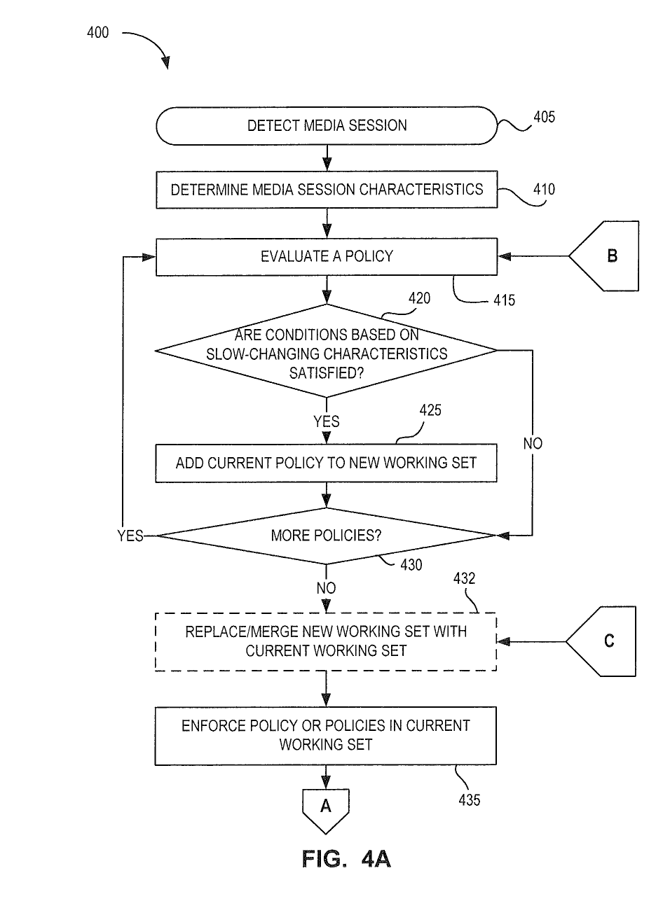

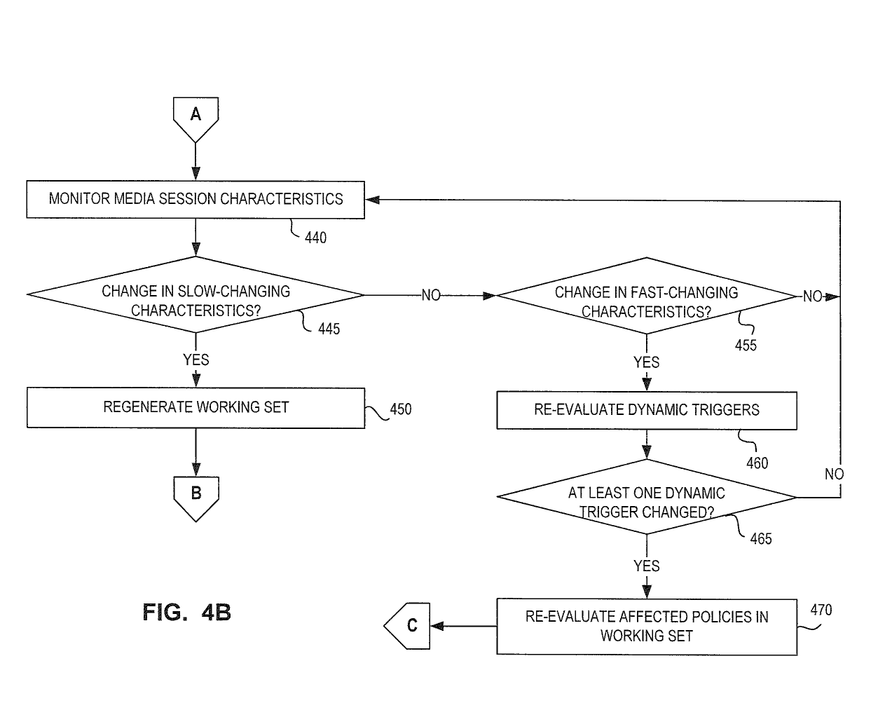

Referring now to FIGS. 4A and 4B, there is illustrated an example method for creating a subset of policies for a media session and dynamically evaluating policies within this subset throughout the life of the media session at a network device, in accordance with at least some embodiments. Off-page connectors A, B and C are used to indicate flow connections between FIGS. 4A and 4B.

Method 400 may be carried out by a network device, such as system 150, and may begin at 405 by detecting establishment of the media session at the network device, as described herein.

Once the media session is detected, system 150 can determine a plurality of characteristics of the media session at 410. The plurality of characteristics may include at least one fast-changing characteristic, or at least one slow-changing characteristic, or both, as described herein.

At 415, system 150 may begin evaluating all policies from a general set of media session policies to generate a new working set of policies for a given media session, beginning with a first policy and iterating until all policies within the general set have been initially evaluated. Evaluation may be done in a prioritized order, for example, based on priorities 340. Evaluation can be carried out by identifying one or more rules applicable to each session policy and evaluating the expressions defined by those rules against the slow-changing or fast-changing characteristics associated with the media session and applicable to the expressions.

At 420, system 150 evaluates the expressions of the current policy under consideration. For example, evaluation may be performed using the quaternary logic approach described herein. In the quaternary logic approach, conventional binary logic states (“TRUE”, “FALSE”) can be supplemented with additional “SOFT” states (e.g., “SOFT-TRUE” and “SOFT-FALSE”). This allows a rule expression to produce a “TRUE”, “SOFT-TRUE”, “SOFT-FALSE” or “FALSE” result. Policies whose rules produce a “TRUE”, “SOFT-TRUE” or “SOFT-FALSE” result can be selected for inclusion in the new working set at 425.

In some other embodiments, evaluation can be performed using a similar ternary logic approach, in which there are three states (“TRUE”, “SOFT-FALSE” and “FALSE”).

A session policy that is unlikely to be satisfied during the lifetime of the media session, for example because a slow-changing characteristic causes an expression to always evaluate as “FALSE”, can be eliminated, either discarded or ignored from the new working set.

Accordingly, the new working set of policies will generally be a subset compared to the general set of media session policies, and will have fewer policies as a result. In the quaternary logic approach, the expressions of the policies remaining in this working set either fully match the media session characteristics (“TRUE”) or partially match (“SOFT-TRUE”, “SOFT-FALSE”), such that at least the sub-expressions depending on slow-changing characteristics of the media session will evaluate as “TRUE”. For those that partially match, the Boolean state (“TRUE”, “FALSE”) of each dynamic trigger (each sub-expression that depends on a fast-changing characteristic) may be recorded. For example, a list of dynamic triggers in the working set may be recorded so that whenever a fast-changing characteristic changes, it is possible to quickly determine if one or more policies in the working set will be impacted by this change.

At 430, system 150 determines whether there are any additional session policies in the original set to be evaluated and, if there are, returns to 415 to evaluate the next session policy.

If there is already a current working set (e.g., because a working set was previously generated), then at 432, system 150 replaces the current working set with the new working set. In some embodiments, this replacement can be performed using a merge operation as described below.

At 435, system 150 may enforce one or more selected policies from the current working set of session policies. In the quaternary logic approach in particular, those policies with rule expressions that evaluate to “TRUE” or “SOFT-TRUE” can be enforced. Thus, while a session policy may be included in the working set even if is not satisfied by a fast-changing characteristic, it may not be enforced (e.g., those policies with rule expressions that evaluate to “SOFT-FALSE”). Accordingly, actions associated with a session policy whose rules are not satisfied will not be carried out.

System 150 continues to monitor, at 440, media session characteristics periodically throughout the lifetime of the media session to detect changes in both slow- and fast-changing characteristics. Monitoring may occur at preselected intervals, for example once every second. Optionally, monitoring may occur in response to an event received from an external source or another module of system 150.

In the course of monitoring, system 150 may determine that a slow-changing characteristic has changed. At 445, system 150 detects the change and causes a reset of the working set of session policies at 450. The reset may involve conceptually merging a new working set with the current working set, similar to 432.

For example, in some embodiments, the merging and enforcement of a new working set A may be performed in an optimized way using a merge operation on a current working set B. Beginning with set B, policies belonging to the set B−(A∩B) may be removed from the current working set and dis-enforced, those policies belonging to set A∩B may continue to be enforced and retained in the current working set, and new policies belonging to set A−(A∩B) may be added to the current working set and enforced.

In some cases, following a reset of the working set at 450, system 150 may revert to monitoring the original, general set of media session policies. In other cases, system 150 may return to 415 and begin re-evaluating the general set of media session policies to create a new working set to be used for the remainder of the media session lifetime, or until a further change occurs in a slow-changing characteristic.

The described embodiments allow for session policies to be initially selected regardless of the current state of fast-changing characteristics, but rather based on the likelihood of a rule expression to potentially evaluate positively during the lifetime of a session. This initial pre-selection need not be performed at the start of the media session, but once performed allows for incremental re-evaluation.

In the course of monitoring a media session, system 150 may determine that a fast-changing characteristic has changed. At 455, system 150 detects the change and carries out a re-evaluation of the dynamic triggers that depend on this characteristic at 460. Since the re-evaluation only affects the dynamic triggers in each rule expression, the full rule expressions need not be re-evaluated. Rather, the rule expressions can be partially re-evaluated to consider only the affected dynamic triggers. In some embodiments, the dynamic triggers may be stored in a separate data structure and associated with the full rule expression, to facilitate fast re-evaluation.

At 465, system 150 may detect that the result of one of the re-evaluated dynamic triggers has changed, which causes a re-evaluation of the policies within the working set that contain the dynamic trigger at 470.

An example policy will now be described to illustrate the use of quaternary logic when evaluating rule expressions. It will be understood that example policy P1 is one of many possible policies that can be created based on fast- and slow-changing characteristics, and other variables and constants. Policy P1 has a rule R1 with the following expression:

IF VideoCodec is ‘A’ AND PresentationQoE>3 THEN do action

In this example, there is a slow-changing characteristic “VideoCodec”, which represents the type of video codec, and a fast-changing characteristic “PresentationQoE”, which represents a current or measured Quality of Experience.

According to the described embodiments, P1 can be included in a working set if the slow-changing characteristic (VideoCodec) satisfies the condition within the expression. However, PresentationQoE may vary from moment to moment, depending on the content. To determine whether P1 should be included in the working set for a current media session, the following binary logic table may be used:

TABLE 1
R1 binary logic truth table
IF VideoCodec is ‘A’ AND PQoE > 3 THEN do action

| | Codec | PQoE | Codec is ‘A’? | PQoE > 3? | Result |
|---|---|---|---|---|---|
| S1 | A | 2 | TRUE | FALSE | FALSE |
| S2 | B | 2 | FALSE | FALSE | FALSE |
| S3 | A | 4 | TRUE | TRUE | TRUE |
| S4 | B | 4 | FALSE | TRUE | FALSE |

It can be observed that only one media session, S3, evaluates to “TRUE”. Thus, in a binary logic approach in which a working set is created by evaluating policies only at the start of a media session, policy P1 may be omitted if PQoE is less than 3 (as in the case of media session S1), even though PQoE could change very quickly.

In a quaternary logic approach, additional logic states can be defined as follows:
FALSE: The session characteristics do not (and likely will not) satisfy a rule expression of the policy. This is most likely to occur in the case of a slow-changing characteristic. The policy is a good candidate for exclusion from a working set.
TRUE: The session characteristics do (and likely will continue to) satisfy a rule expression of the policy. The policy is a good candidate for inclusion in a working set.
SOFT-FALSE: The session characteristics do not presently fully satisfy a rule expression of the policy, but are likely to do so within the lifetime of the media session. This is most likely to occur in the case of a fast-changing characteristic. The policy is a good candidate for inclusion in a working set.
SOFT-TRUE: The session characteristics do presently fully satisfy a rule expression of the policy, but may not at some point within the lifetime of the media session. This is most likely to occur in the case of a fast-changing characteristic. The policy is also a good candidate for inclusion in a working set.

Table 2 below illustrates a quaternary logic truth table for rule R1, for comparison with Table 1.

TABLE 2
R1 quaternary logic truth table
IF VideoCodec is ‘A’ AND PQoE > 3 THEN do action

| | Codec | PQoE | Codec is ‘A’? | PQoE > 3? | Result |
|---|---|---|---|---|---|
| S1 | A | 2 | TRUE | SOFT_FALSE | SOFT_FALSE |
| S2 | B | 2 | FALSE | SOFT_FALSE | FALSE |
| S3 | A | 4 | TRUE | SOFT_TRUE | SOFT_TRUE |
| S4 | B | 4 | FALSE | SOFT_TRUE | FALSE |

It can be observed that two media sessions, S1 and S3, produce “soft” results that would be candidates for inclusion in a working set. Notably, for S3, even though PQoE is presently greater than 3, only a “SOFT_TRUE” result is produced, because PQoE is a fast-changing characteristic.

A policy expression may consist of one or more relational expressions connected by a logical operator (AND, OR, NOT) to form a logical expression. The rules for combining quaternary relational expressions into logical expressions can be formed as follows:

TABLE 3
Quaternary logic AND table

| AND | FALSE | SOFT_FALSE | SOFT_TRUE | TRUE |
|---|---|---|---|---|
| FALSE | FALSE | FALSE | FALSE | FALSE |
| SOFT_FALSE | FALSE | SOFT_FALSE | SOFT_FALSE | SOFT_FALSE |
| SOFT_TRUE | FALSE | SOFT_FALSE | SOFT_TRUE | SOFT_TRUE |
| TRUE | FALSE | SOFT_FALSE | SOFT_TRUE | TRUE |

TABLE 4
Quaternary logic OR table

| OR | FALSE | SOFT_FALSE | SOFT_TRUE | TRUE |
|---|---|---|---|---|
| FALSE | FALSE | SOFT_FALSE | SOFT_TRUE | TRUE |
| SOFT_FALSE | SOFT_FALSE | SOFT_FALSE | SOFT_TRUE | TRUE |
| SOFT_TRUE | SOFT_TRUE | SOFT_TRUE | SOFT_TRUE | TRUE |
| TRUE | TRUE | TRUE | TRUE | TRUE |

TABLE 5
Quaternary logic NOT table

| NOT | |
|---|---|
| FALSE | TRUE |
| SOFT_FALSE | SOFT_TRUE |
| SOFT_TRUE | SOFT_FALSE |
| TRUE | FALSE |

It will be appreciated that numerous specific details are set forth in order to provide a thorough understanding of the exemplary embodiments described herein. However, it will be understood by those of ordinary skill in the art that the embodiments described herein may be practiced without these specific details. In other instances, well-known methods, procedures and components have not been described in detail so as not to obscure the embodiments described herein. The scope of the claims should not be limited by the preferred embodiments and examples, but should be given the broadest interpretation consistent with the description as a whole.

We claim:

1. A method of selecting session policies for a media session at a network device, the method comprising:
detecting establishment of the media session at the network device;
determining a plurality of characteristics of the media session;
evaluating a set of session policies, based on at least one of the characteristics, to select a working set of session policies; and
including a selected session policy for the media session in the working set of session policies, wherein the selected session policy has an expression that is not satisfied by each of the plurality of characteristics of the media session applicable to the selected session policy, and wherein the selected session policy is unenforced.

2. The method of claim 1, wherein the plurality of characteristics comprise at least one fast-changing characteristic, and wherein the expression of the selected session policy is not satisfied by the at least one fast-changing characteristic when the set of session policies is initially evaluated.

3. The method of claim 2, wherein the at least one fast-changing characteristic is selected from the group consisting of a subscriber location, a location utilization load level, a current audio bit rate, a current video bit rate, an audio sampling rate, a number of audio channels, a video resolution, a video frame rate, an adaptive streaming control point, a current quality level, and a current quality metric for the media session.

4. The method of claim 1, wherein the plurality of characteristics comprise at least one slow-changing characteristic, and wherein the working set is selected by eliminating session policies with expressions that are not satisfied by the at least one slow-changing characteristic.

5. The method of claim 4, wherein the at least one slow-changing characteristic is selected from the group consisting of a subscriber identity, a subscriber plan, a time of day, a device identity, a device type, a device capability, a display size, a display resolution, a service type, a server address, a content duration, a streaming protocol, a media container, an audio codec and a video codec.

6. The method of claim 1, wherein the plurality of characteristics comprises at least one fast-changing characteristic, the method further comprising:
monitoring the plurality of characteristics during the media session; and
in response to a change in the plurality of characteristics, enforcing the selected session policy when the expression is satisfied by each of the plurality of characteristics of the media session applicable to the selected session policy.

7. The method of claim 6, wherein the plurality of characteristics further comprises at least one slow-changing characteristic, and wherein the change is a change in the at least one fast-changing characteristic and each of the at least one slow-changing characteristic applicable to the selected session policy remains unchanged.

8. The method of claim 6, further comprising re-evaluating the selected session policy prior to the enforcement.

9. The method of claim 8, wherein the re-evaluating is performed by evaluating a sub-expression of the selected session policy, wherein the sub-expression is based on the at least one fast-changing characteristic.

10. The method of claim 6, further comprising selecting a new working set of session policies in response to a change in the at least one slow-changing characteristic.

11. The method of claim 1, further comprising including a second session policy for the media session in the working set of session policies, wherein the second session policy has an expression that is satisfied by each of the plurality of characteristics of the media session.

12. A non-transitory computer-readable medium storing instructions executable by a processor of a computer, the instructions which when executed by the processor cause the computer to carry out a method for selecting session policies for a media session at a network device, the method comprising:
detecting establishment of the media session at the network device;
determining a plurality of characteristics of the media session;
evaluating a set of session policies, based on at least one of the characteristics, to select a working set of session policies; and
including a selected session policy for the media session in the working set of session policies, wherein the selected session policy has an expression that is not satisfied by each of the plurality of characteristics of the media session applicable to the selected session policy, and wherein the selected session policy is unenforced.

13. An apparatus for selecting session policies for a media session at a network device, the apparatus comprising:
a memory;
a network interface; and
a processor, the processor configured to:
detect establishment of the media session;
determine a plurality of characteristics of the media session;
evaluate a set of session policies, based on at least one of the characteristics, to select a working set of session policies; and
include a selected session policy for the media session in the working set of session policies, wherein the selected session policy has an expression that is not satisfied by each of the plurality of characteristics of the media session applicable to the selected session policy, and wherein the selected session policy is unenforced.

14. The apparatus of claim 13, wherein the plurality of characteristics comprise at least one fast-changing characteristic, and wherein the expression of the selected session policy is not satisfied by the at least one fast-changing characteristic when the set of session policies is initially evaluated.

15. The apparatus of claim 13, wherein the plurality of characteristics comprise at least one slow-changing characteristic, and wherein the working set is selected by eliminating session policies with expressions that are not satisfied by the at least one slow-changing characteristic.

16. The apparatus of claim 13, wherein the plurality of characteristics comprises at least one fast-changing characteristic, wherein the processor is further configured to:
monitor the plurality of characteristics during the media session; and
in response to a change in the plurality of characteristics, enforce the selected session policy when the expression is satisfied by each of the plurality of characteristics of the media session applicable to the selected session policy.

17. The apparatus of claim 16, wherein the plurality of characteristics further comprises at least one slow-changing characteristic, and wherein the change is a change in the at least one fast-changing characteristic and each of the at least one slow-changing characteristic applicable to the selected session policy remains unchanged.

18. The apparatus of claim 16, wherein the processor is further configured to re-evaluate the selected session policy prior to the enforcement.

19. The apparatus of claim 18, wherein the re-evaluating is performed by evaluating a sub-expression of the selected session policy, wherein the sub-expression is based on the at least one fast-changing characteristic.

20. The apparatus of claim 16, further comprising selecting a new working set of session policies in response to a change in the at least one slow-changing characteristic.
